(19) United States
(12) Patent Application Publication
(10) Pub. No.: US 2003/0095214 A1
(43) Pub. Date: May 22, 2003

(54) Monitor fabrication method and device

(76) Inventors: Kuo-Wen Chen, Hsin-Chu City (TW); Fan-Chieh Chang, Hsin-Chu City (TW)

Correspondence Address: NAIPO (NORTH AMERICA INTERNATIONAL PATENT OFFICE), P.O. BOX 506, MERRIFIELD, VA, 22116, US

(21) Appl. No.: 10/065,713

(22) Filed: Nov. 13, 2002

(30) Foreign Application Priority Data
Nov. 16, 2001 (TW) 090128779

(51) Int. Cl. H04N 5/64

(52) U.S. Cl. 348/836

(57) ABSTRACT

A method of fabricating a monitor includes fabricating a display unit having a back edge section, forming an adhesive section on the back edge section of the display unit, adhering a first surface of at least one aluminum frame to the adhesive section of the display unit, and fixing a second surface of the aluminum frame to the back cover. The adhering is accomplished with a double-sided tape. The fabrication method offers simple execution and prevents damage to an optical display unit.

### BACKGROUND OF INVENTION

1. Field of the Invention

The present invention relates to a rear-projection display device, and more particularly, to a monitor fabrication method and related rear-projection display device.

2. Description of the Prior Art

Recently, information visualization, especially with monitors and display devices, is widely increasingly important. Fabricating monitors easily and quickly to save time and money, and keeping quality of monitors high and popular in the market is an important topic.

FIG. 1 is a cross-sectional view of a monitor according to the prior art. For fabrication, first, a first optical element 111, a second optical element 112, and a glass screen 113 are combined to form a display unit 11. The display unit 11 is set on a perimeter of a plastic frame 13 and fixed by a plurality of sheet metal pieces 12 on the perimeter of a back side of the display unit 11. One end of each sheet metal piece 12 holds the display unit 11 and another end receives a plurality of screws 133 screwed to a plurality fixing pillars 131 of the plastic frame 13 to fix the display unit 11 to the plastic frame 13 to form a monitor module 10. Additionally, the plastic frame 13 has a plurality of support pillars 132, and a wooden frame 14 has a plurality of support pieces 141 at a location corresponding to the support pillars 132. A plurality of screws 142 are used to screw the support pieces 141 to the support pillars 132 to combine the monitor module 10 with the wooden frame 14. Lastly, a plurality of screws 151 is screwed into an edge of the back cover 15 to the wooden frame 14 to form the monitor.

The above-mentioned is a fabrication method of a monitor according to the prior art. As shown in FIG. 2, the steps include first combining the display unit 11. Then, fixing the display unit 11 to the plastic frame 13, screwing the sheet metal pieces 12 to the plastic frame 14 with screws 133 to form the monitor module 10, and fixing the monitor module 10 to the wooden frame 14. And lastly, combining the wooden frame 14 with the back covers 15 to complete fabrication. This fabrication method of the monitor according to the prior art is complicated and time wasting. Furthermore, the sheet metal pieces 12 can very easily destroy or damage the display unit 11, being made of glass. Moreover, the edge of the plastic frame 13 requires material for the fixing pillars 131 and the support pillars 132. Therefore the plastic frame 13 is very wide. Thus, when viewing the monitor from the front, one sees an unnecessarily thick frame.

### SUMMARY OF INVENTION

It is therefore an objective of the claimed invention to provide a monitor fabrication method and device utilizing an adhesive that can simplify a fabricating process, saving time, and reducing cost.

It is a further objective of the claimed invention to provide a monitor requiring no frame fabrication method and device that can show clearer images.

It is a further objective of the claimed invention to provide a monitor fabrication method and device utilizing an adhesive that can prevent a sheet metal piece from damaging a display unit to enhance fabrication yield.

According to the claimed invention, a method of fabricating a monitor comprises fabricating a display unit having a back edge section, forming an adhesive section on the back edge section of the display unit, adhering a first surface of at least one aluminum frame to the adhesive section of the display unit, and fixing a second surface of the aluminum frame to the back cover.

These and other objectives of the claimed invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a cross-sectional view of structure of a monitor according to the prior art.

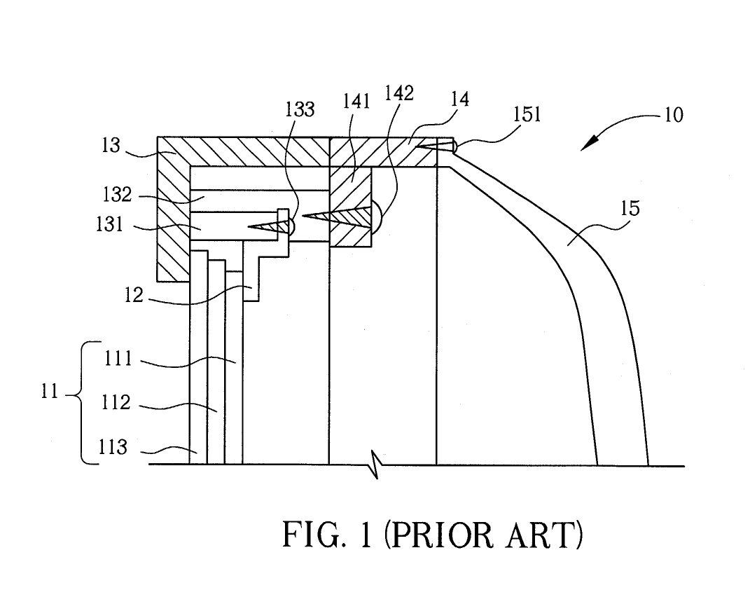

FIG. 2 is a flowchart of a fabrication method of the monitor of FIG. 1.

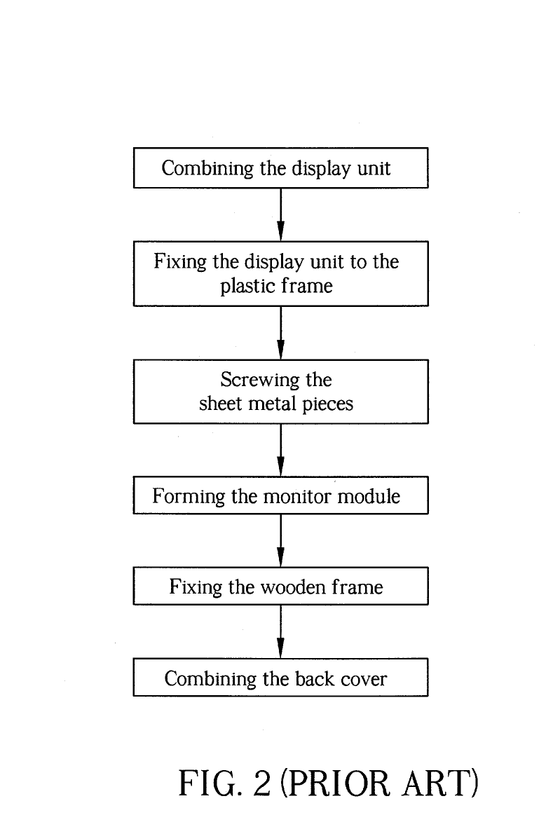

FIG. 3 is a cross-sectional view of first embodiment of a monitor according to the present invention.

FIG. 4 is a front view of the monitor of first embodiment.

FIG. 5 is a flowchart of a fabrication method of the monitor of FIG. 3 according to the present invention.

FIG. 6 is cross-sectional view of second embodiment of a monitor according to the present invention.

### DETAILED DESCRIPTION

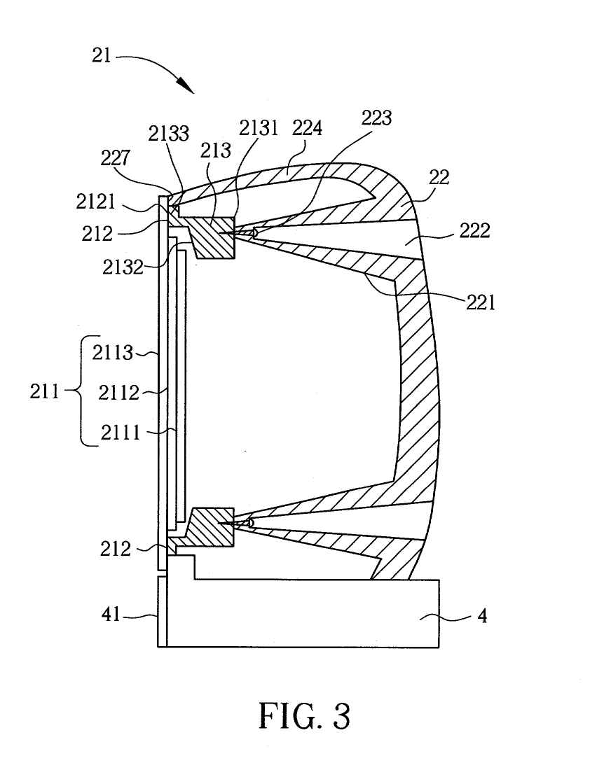

Please refer to FIG. 3. FIG. 3 is a cross-sectional view of a first embodiment of a monitor according to the present invention. Forming the monitor includes adhering a display unit 211 to a plurality of aluminum frames 213 to form a monitor module 21, fixing the monitor module 21 to a back cover 22, then installing a base 4 having a panel 41 on a front surface.

A first optical element 2111 is attached to one side of a second optical element 2112, which is then attached to a backside of a glass screen 2113 having a larger surface area than the second optical element 2112. The first optical element 2111, the second optical element 2112, and a glass screen 2113 form the display unit 211. The second optical element 2112 is adhered to the center of a back side of the glass screen 2113, leaving a region as an adhesive section 2121 on the perimeter of the back side of the glass screen 2113. A double-side adhesive tape 212 is adhered on the adhesive section 2121 of the glass screen 2113. Another surface of the double-side adhesive tape 212 is set on the plurality of aluminum frames 213. Each aluminum frame 213 has a large section 2131 near the display unit 211 . The large section 2131 has an incline 2132 that accommodates the first optical element 2111 and the second optical element 2112, and facilitates decreasing installation space. Another part of the aluminum frame 213 is a L-shaped cross-section 2133. Adhering the L-shaped cross-section 2133 to the double-side adhesive tape 212, thereby attaching the aluminum frame 213 and the display unit 211 forms a monitor module 21.

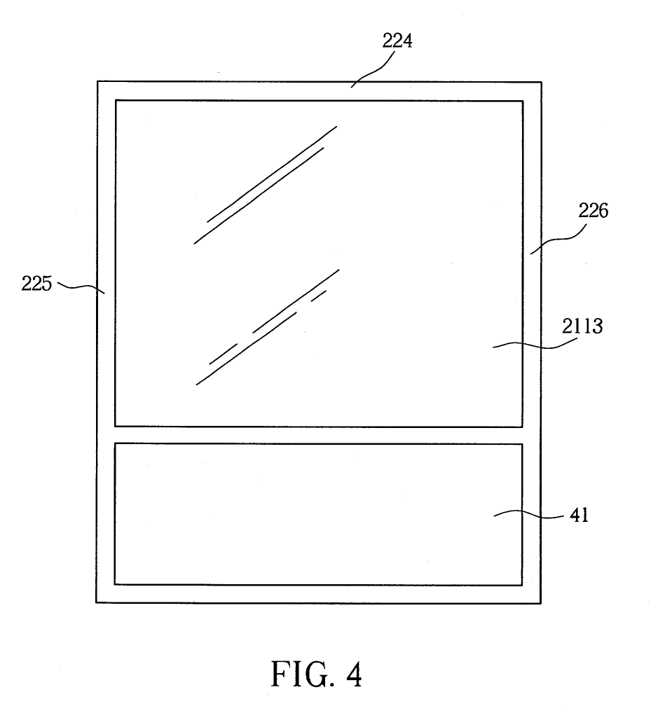

In addition, the back cover 22 has a plurality of combining pillars 221, each combining pillar 221 having a corresponding holes222. Putting a screw 223 in the hole 222 through the combining pillar 221 and screwed into the large section 2131 of the aluminum frame 213 fixes the monitor module 21 to the back cover 22. As shown in FIG. 3 and FIG. 4, for users watching the glass screen 2113 displaying images, the top 224 and two sides 225, 226 of the back cover 22 taper towards the user forming a front edge 227 that is hidden by the back side of the display unit 211 and holds the top edge and two side edges of the back side of the glass screen 2113.

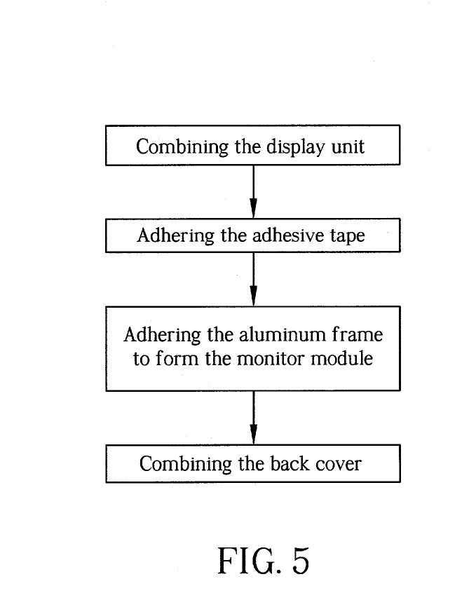

Please refer to FIG. 5. The steps of fabricating a monitor according to the present invention are using the first optical element 2111, the second optical element 2112, and the glass screen 2113 to form the display unit 211, then, adhering the doubled-sided adhesive tape 212 onto a perimeter of the back side of the glass screen 2113, and combining the L-shaped end 2133 of the aluminum frame 213 to the doubled-sided adhesive tape 212 forming the monitor module 21. Lastly, the large section 2131 of the aluminum frame 213 is fixed to the back cover 22 to complete fabrication.

As the techniques of display devices advance, lightweight panel-like display devices (for example, Liquid Crystal Display or rear-projection televisions) are increasing in number to replace heavy bulky CRT devices. The double-sided adhesive tape (such as a 3M product) has the advantage of providing a reliable and permanent connection. With these properties, the display unit 211 according to the present invention uses the double-sided adhesive tape 212 fixed to the back side for adhering to the aluminum frame 213. In this way, the sheet metal 12 and the plastic frame 13 of the prior art can be omitted thereby avoiding the use of screws 133. The aluminum frame 213 according to the present invention is directly fixed to the back cover 15 to eliminate the wooden frame 14 of the prior art. Therefore, the present invention offers simplified fabrication of a monitor, increasing the quality, and decreasing the cost.

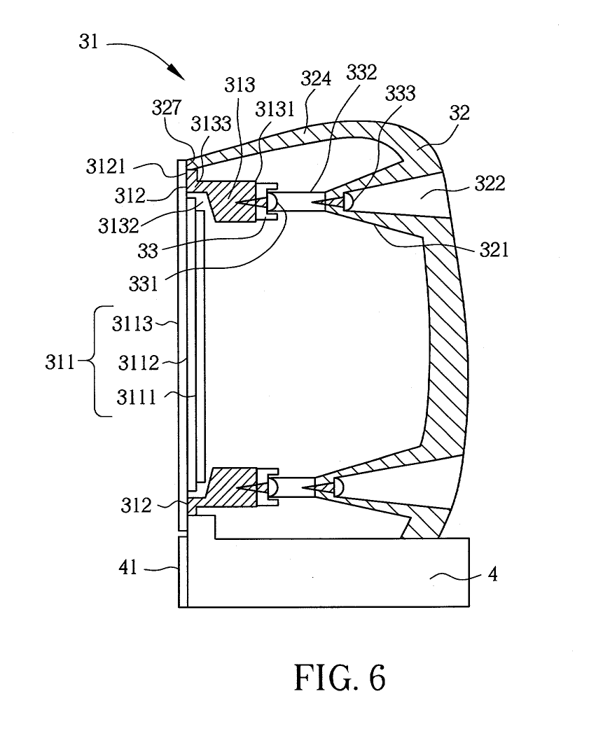

Please refer to FIG. 6. FIG. 6 is a cross-sectional view of second embodiment of a monitor according to the present invention. The basic structure of the second embodiment is roughly the same as with the first embodiment, the main difference being an added frame 33. The second embodiment first uses a first optical element 3111, a second optical element 3112, and a glass screen 3113 to form a display unit 311, then, a double-sided adhesive tape 312 is adhered to a perimeter of a back side of the glass screen 3113, and another surface of the double-sided adhesive tape 312 is adhered to an aluminum frame 313 to form the monitor module 31. A quadrilateral frame 33 having a C-shaped cross-section accepting a plurality of screws 331 is set on a large section 3131 of the aluminum frame 313. The screws 331 penetrate through the frame 33 screwing into the large section 3131 of the aluminum frame 313 to fix the monitor module 31 to the frame 33. The C-shaped cross-section of the frame 33 accommodates a plurality of fixing pillars 332. A back cover 32 of the display device has a plurality of combining pillars 321 at locations corresponding to the fixing pillars 332. The back cover 32 has a plurality of holes 322 at locations corresponding to the combining pillars 332. A screw 323 in installed through the combining pillar 321 screwing the fixing pillar 332 to fix the monitor module 31 to the back cover 32 through the frame 33 to form the monitor. The second embodiment according to the present invention uses the frame 33 to form a strengthened combination that enhances the stability of the aluminum frame 313.

In contrast to the prior art, the present invention method of fabricating a monitor is capable of simplifying fabrication procedures, saving fabrication time, and eliminating sheet metal pieces that could potentially damage or destroy the optical display unit. Furthermore, the fabrication method of the present invention is easier and faster to execute.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A method of fabricating a monitor comprising:
fabricating a display unit having a back edge section, forming an adhesive section on the back edge section of the display unit;
adhering a first surface of at least one aluminum frame to the adhesive section of the display unit; and
fixing a second surface of the aluminum frame to a back cover.

2. The method of claim 1 wherein the display unit comprises a first optical element, a second optical element, and a glass screen having a back side having a center section.

3. The method of claim 2 wherein the glass screen has a larger surface area than the second optical element, the second optical element being integrated onto the center section of the glass screen leaving a perimeter of the back side of the glass screen uncovered for fixing the adhesive section to, the perimeter of the back side of the glass screen covering a front edge of the back cover.

4. The method of claim 1 wherein the adhesive section is a double-sided adhesive tape.

5. The method of claim 1 wherein the second end of the aluminum frame is combined with a second frame, the second frame being fixed to the back cover.

6. A monitor comprising:
a display unit having an adhesive section formed on a perimeter of a back side;
at least one aluminum frame having a first end and a second end, the first end being adhered to the adhesive section, the second being a large section; and
a back cover having a back side forming a plurality of combining pillars, each combining pillar for being fixed to the large section of the aluminum frame.

7. The monitor of claim 6 wherein the display unit further comprises a first optical element, a second optical element, and a glass screen.

8. The monitor of claim 7 wherein the glass screen has a larger area than the second optical element, and the second optical element is integrated onto a center of a back side of the glass screen leaving the adhesive section uncovered around a perimeter of the back side of the glass screen.

9. The monitor of claim 6 wherein the adhesive section is a double-sided adhesive tape.

10. The monitor of claim 6 wherein the back cover further comprises a top section and two lateral sections tapered towards the display unit and forming a front edge, the front edge abutting to the back side of the display unit for fixing corresponding top and lateral edges of the back side of the grass screen.

11. The monitor of claim 6 wherein the aluminum frame is beveled to accommodate the display unit.

12. The monitor of claim 6 further comprising a second frame between the second end of the aluminum frame and the combining pillars of the back cover.

13. The monitor of claim 12 wherein the second frame has a quadrilateral cross-section.

14. The monitor of claim 12 wherein the second frame has a C-shaped cross-section.
